(19) United States
(12) Patent Application Publication
(10) Pub. No.: US 2004/0230555 A1
(43) Pub. Date: Nov. 18, 2004

(54) System and method for representing a relational database as a java object

(76) Inventors: John Phenix, Broadstone (GB); Nicholas Clive Judge, Ferndown (GB)

Correspondence Address: Michael B. Johannesen, Esq., Lowenstein Sandler, P.C., 65 Livingston Avenue, Roseland, NJ, 07068, US

(21) Appl. No.: 10/667,650

(22) Filed: Sep. 22, 2003

Related U.S. Application Data
(60) Provisional application No. 60/471,309, filed on May 16, 2003.

(51) Int. Cl. G06F 7/00

(52) U.S. Cl. 707/1

(57) ABSTRACT

A system and method that provides for representation of any sophisticated relational database model as a set of automatically when needed generated Java bean objects. The system simplifying relational database development in terms of initial development time and ongoing maintenance without being tied to a particular J2EE technology or database or external service/third-party product. Advantageously the model object mapping code is generated either from DDL or directly from the metadata from a database, or from another source. The system and methods allows for high-performance gains and flexibility via a number of configurable parameters enabling complex primary/foreign key relationships to be modeled. The code generation is vendor specific advantageously allowing specific database vendor SQL hints to be added to generated code to improve performance.

### CROSS-REFERENCE TO RELATED APPLICATION

This patent application is related to and claims the benefit of Provisional U.S. Patent Application No. 60/471,309 filed May 16, 2003, which application is hereby incorporated herein by reference in its entirety.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates to the field of relational databases, and, more specifically, to a representation of a relational database as a Java Object.

### BACKGROUND OF THE INVENTION

Relational databases, in general, comprise a plurality of records related to a common item or “thread.” Such databases are data structures organized into rows and columns, much in the manner of a spread sheet. These databases were originally designed for access from procedural programs and were optimized for such linear programming.

In modern, object-oriented systems, accessing such relational databases can be challenging. Each object must map the data from the database into a form suitable for its own purpose. Therefore, there is a need in the art to represent relational database tables as objects which have the capability of being “persistable.”

### SUMMARY OF THE INVENTION

This problem is solved and a technical advance is achieved in the art by a system and method that provides for the representation of any sophisticated relational database model as a set of automatically generated Java bean objects, including the capabilities of get/set methods, default constructors, serializable compliance, etc. The system simplifying relational database development in terms of initial development time and ongoing maintenance without being tied to a particular J2EE technology or database or external service/third-party product. Each database table is modeled by a Java bean object; and advantageously allows for the modeling of inheritance relationships, order criteria for any child/foreign key relationships, and importantly incremental loading and saving of specific “branches” of a relationship. The incremental operations allows for potential speed improvements as only a partial database model is held as a Java bean without loosing database integrity.

The mapping takes a bottom-up approach so placing most importance on getting the database model correct, and advantageously the model object mapping code is generated either from DDL (Database Description language) or directly from the metadata from a database, or from another source. The system and methods allows for high-performance gains and flexibility via a number of configurable parameters enabling complex primary/foreign key relationships to be modeled. The code generation is vendor specific advantageously allowing specific database vendor SQL hints to be added to generated code to improve performance. Further more code generation is highly configurable as most methods can be overloaded to decorate functionality if required. The generated object code is separated from the value-added business logic relationships.

An exemplary embodiment of this invention, called “Business Object Model” (herein “BOM”), provides a table in a relational database that typically effects a subclass from the AbstractBOM class. The BOM also overloads the load and remove public methods for handling child relationships and any of the methods wherein a child relationship needs to be defined (e.g., deleteOwnChildrenBeforeParent). The isinDatabase method is changed to reflect criteria for that BOM already being in the database.

Each BOM includes a reference to the primary key, which has a one-to-one mapping to a database table entry. Each new BOM created has an associated primary key reference, which conforms to a serializable handle reference. A BOM may be accessed independently from a primary key (as a foreign key relationship). All relationships of this type are defined in a finder definition interface.

### BRIEF DESCRIPTION OF THE DRAWINGS

A more complete understanding of this invention may be obtained from a consideration of this specification taken in conjunction with the drawings, in which:

FIG. 1 is a Business Object Model Pattern, AbstractBOM, defined according to an exemplary embodiment of this invention;

FIG. 2 is exemplary code for a remove method according to an exemplary embodiment of this invention;

FIG. 3 is exemplary code for a load method according to an exemplary embodiment of this invention;

FIG. 4 is exemplary code for a save method according to an exemplary embodiment of this invention;

FIG. 5 is an overview illustration of an Automatic Code Generation Infrastructure according to an exemplary embodiment of this invention, showing the relationship among FIGS. 6-12;

FIG. 6 is an exemplary ClassMetaData definition of the Automatic Code Generation Infrastructure of FIG. 5;

FIG. 7 is an exemplary OracleClassMetaData definition of the Automatic Code Generation Infrastructure of FIG. 5;

FIG. 8 is an exemplary RelationshipManager definition of the Automatic Code Generation Infrastructure of FIG. 5;

FIG. 9 is an exemplary JavaSourceGenerator definition of the Automatic Code Generation Infrastructure of FIG. 5;

FIG. 10 is an exemplary JavaSourceBuilder and related structures definition of the Automatic Code Generation Infrastructure of FIG. 5;

FIG. 11 is an exemplary RelationshipXMLManager definition of the Automatic Code Generation Infrastructure of FIG. 5;

FIG. 12 provides exemplary MetaData and ClassRelationshipMetaData definitions of the Automatic Code Generation Infrastructure of FIG. 5;

FIG. 13 is a normal example of relationship reference code according to an exemplary embodiment of this invention;

FIG. 14 is a foreign key example of relationship reference code according to an exemplary embodiment of this invention;

FIG. 15 is an example of optimization hints according to an exemplary embodiment of this invention;

FIG. 16 is an example of partition hints according to an aspect of this invention;

FIG. 17 is an example of primary key field hints in accordance with another aspect of this invention;

FIG. 18 is an example of information for the code generator;

FIG. 19 is a template example of generated code;

FIG. 20 is an exemplary child relationship code according to an exemplary embodiment of this invention;

FIG. 21 is an example of generated code for a child relationship according to an exemplary embodiment of this invention;

FIG. 22 is exemplary foreign key finder helper code according to an exemplary embodiment of this invention;

FIG. 23 shows an example relationship reference for inheritance;

FIG. 24 shows an example of the code automatically generated from this inheritance relationship;

FIG. 25 shows how the relational tables map to the object model; and

FIGS. 26-28 comprise an exemplary relationship.xml snapshot according to an exemplary embodiment of this invention.

### DETAILED DESCRIPTION

All methods and classes are shown herein in bold font in this disclosure.

Class Synopsis

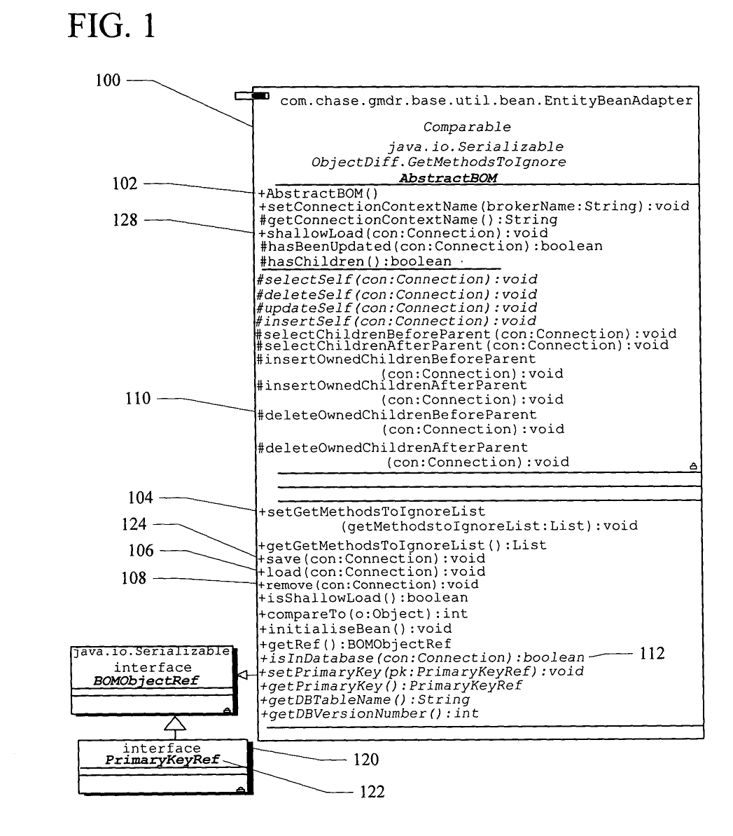

Turning now to FIG. 1, a model design of an exemplary Business Object Model (BOM) 100 is shown. For purposes of this exemplary embodiment, BOM 100 uses the Java object-oriented language. The model 100 of FIG. 1 illustrates the typically design pattern for BOM creation in Java. A table in a relational database typically has as a superclass the AbstractBOM class 102 and overloads several public methods, including the public load method 106 and the public remove method 108 for handling child relationships. Further, any of the methods that are child relationship need to be defined in (e.g., deleteOwnChildrenBeforeParent 110). The isInDatabase method 112 is changed to reflect criteria for that BOM already being in the database (e.g., optimistic locking via a version or timestamp database field).

The method setGetMethodsToIgnoreList 104 is an implementation of the ObjectDiff.GetMethodsToIgnore interface, used to filter out methods that do not form part of the criteria for BOM object instance comparisons.

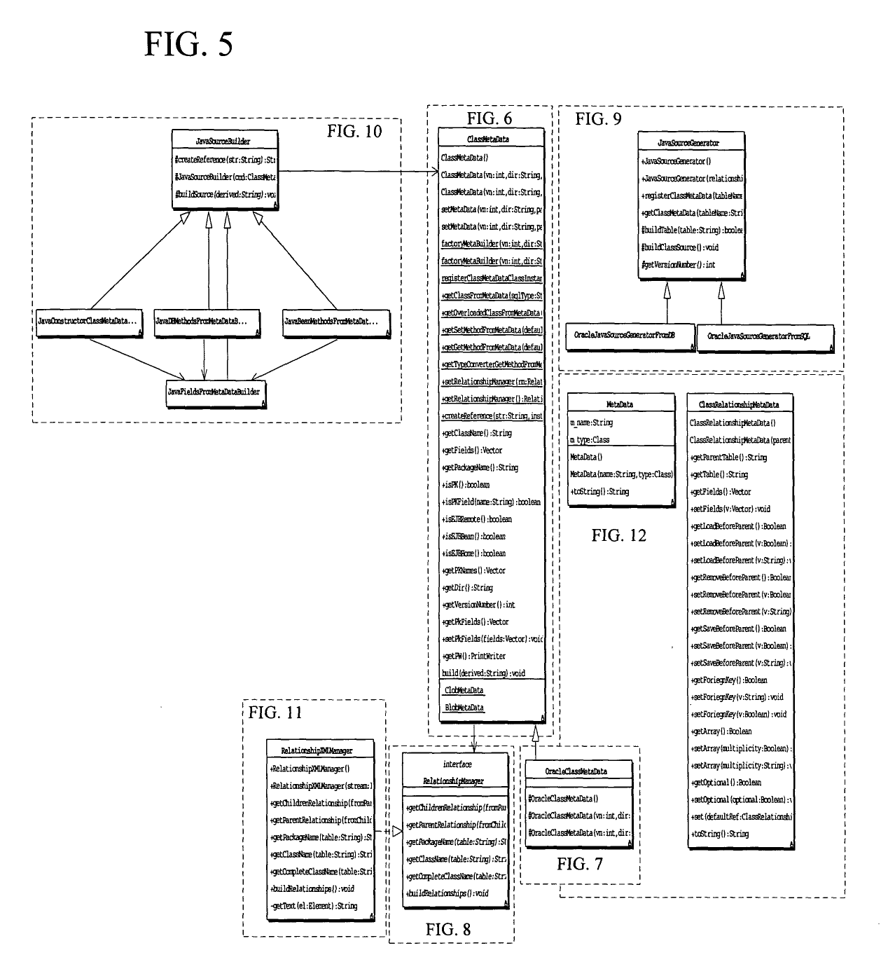

Each BOM 100 has a reference to the primary key 120, which is labeled “PrimaryKeyRef” 122 in this exemplary embodiment. PrimaryKeyRef 122 has a one-to-one mapping to a database table entry. Each new BOM 100 created has an associated primary key reference, which conforms to a serializable handle reference. A BOM 100 may also be accessed independently from a primary key (as a foreign key relationship). All relationships of this type should be defined in a finder definition interface (see relationship mapping in the generation code section discussed below in connection with FIGS. 5-12).

The AbstractBom 102 class encapsulates the requirements of a persistable Java object model. From a client's perspective there are only two methods that are of interest in terms of transaction control (and object persistence): load method 106 and save method 124. These methods are defined so that a save 124 updates if already existing in the database, and a load 106 always loads the latest instance of the table data represented as a Java bean. Client code (typically generated code) will overload these methods with the associated child relationships.

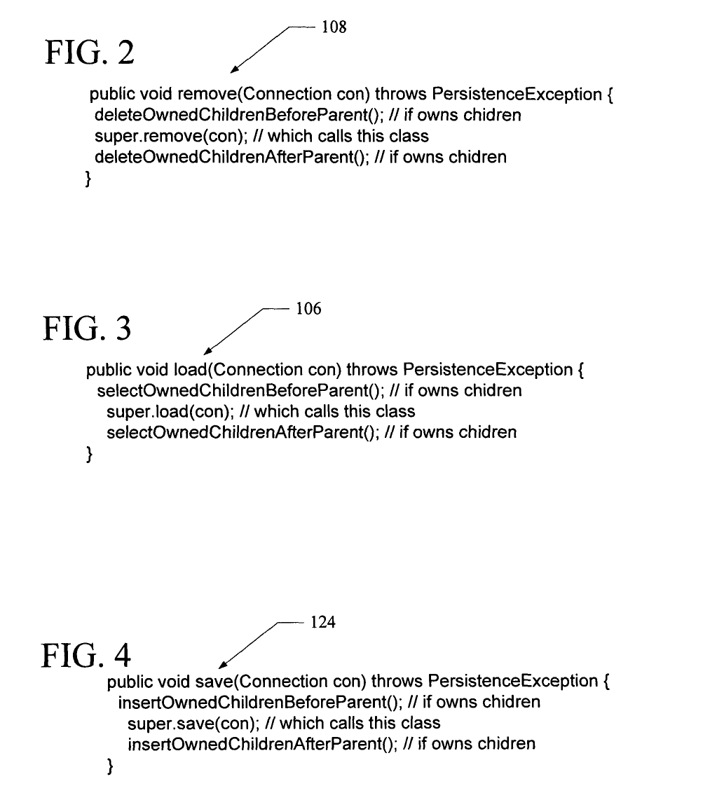

The remove method 108 decides how to remove from a BOM the database. The remove method 108 should be overloaded to remove itself and children. The order is ownership specific, but a typical remove method 108 is illustrated in FIG. 2.

The load method 106 decides on how to restore a BOM 100 from a database. The load method 106 should be overloaded to load self and children. The order is ownership specific, but a typical load method 106 is illustrated in FIG. 3.

The save method 124 decides on how to persist a BOM to a database. The save method 124 should be overloaded to save self and children. The order is ownership specific, but a typical save method 124 is illustrated in FIG. 4.

Transaction Control

Transaction control is implicit from the database connection passed to a BOM 100. This is advantageous because control is implicit by the instance of the connection being passed. Transaction control is therefore not part of BOM 100; this exemplary embodiment of the BOM is free from any third-party product requirement and is advantageously very light weight.

Model Design Issues

SQL is used as the relational to Java object mapping because the database model is best optimized this way rather than having to be created top-down from the BOM model.

Generated Code

A further advantage of this invention is automatic generation of BOM code. Automatic code generation is described in connection with FIGS. 5-12. The infrastructure outlined below in connection with FIGS. 5-12 is to enable the creation of Java source code to represent a database table and all its relationships as a Java bean. In all cases the generation is biased towards a bottom up approach. The source for Java bean generation is derived from a database source of some flavor. The current code generation creates a BOM and the entire child associated relationships automatically.

As a client, a BOM can typically be used “off the shelf.” Only some foreign key relationships may need to be added to a class if such a relationship cannot be defined. For example, generated code will not generate a foreign key relationship where the parent table field name is NOT the same as the child field name.

Below is a synopsis of key interface/classes and relationship representation. In the following examples, all generated code is prefixed with “Gen,” all table/field names are converted to Camel Case (e.g., AAA_BBB_CCC is be converted to AaaBbbCcc) and all generated BOMS are abstract.

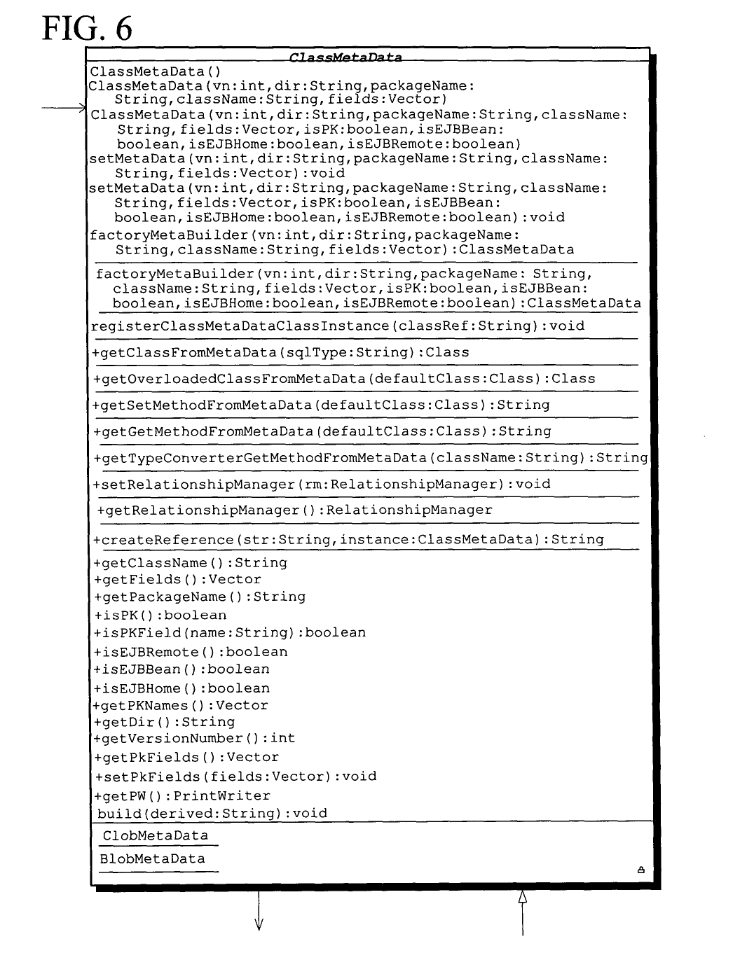

FIG. 5 is an overview diagram of the relationship among FIGS. 6-12. Each of FIGS. 6-12 is an enlargement of the relative box or boxes in FIG. 5, so that one skilled in the art may take this diagram and use it as a roadmap to build an automatic code generation infrastructure as shown in FIG. 5.

Meta Data Relationship Classes

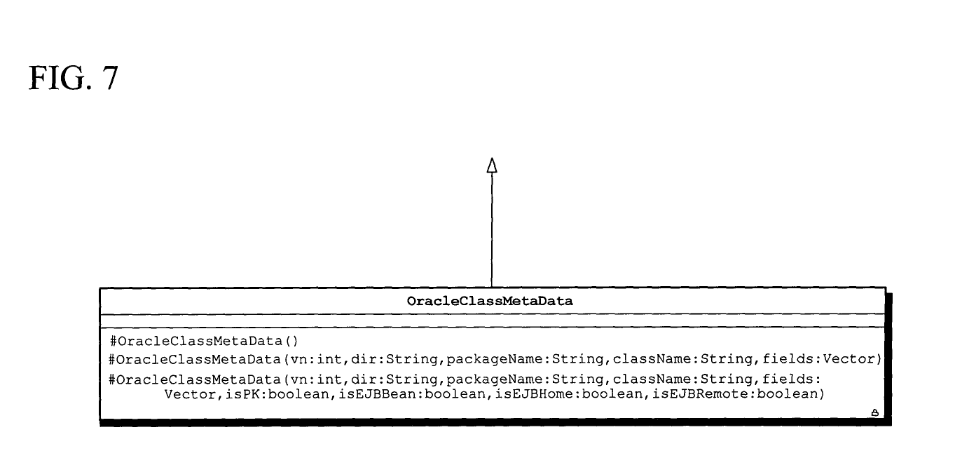

Turning now to FIG. 6, the abstract class ClassMetaData represents the container for meta data, that is, the data that defines the relationship between a database type and the equivalent Java type. The look-up table defined in this class (s_DBMetaData) is populated with meta-data type relationships for vendor specific conversions, and also for the flavors of transformations required. Typically, this is the only thing a subclass will add to the base class. Currently the product has been implemented for Oracle, so the real implementation handles Java to Oracle type relationships, the class being OracleClassMetaData (FIG. 7).

s_DBMetaData is a java.util.Hashtable instance, which contains name/value transformation code generation data. The transformation references are defined in four categories outlined below:

1. Read Data (type converter for Java to database types)

a. name (string)

b. Represents the default meta data type held in the database (e.g., number)

c. value (Java class)

d. Represent the associated Java class to handle this database type (e.g., Long.class)

2. Write Data (Java to Database mapping)

a. name (Java class)

b. Represents the Java class which requires to be written to the database (e.g., Long.class)

c. value (string)

d. Represent the method to be called to write instance out (typically JDBC wrapper) NOT including the value, e.g. “SQLUtil.setLong(ps, index++)”

3. Read Type Converters (prefix class name with “TypeConverter.”, Database to Java mapping)

a. name (string)

b. Represents a fully qualified Java class name which needs type conversion, e.g., “s_TypeConverter+“java.sql.Timestamp””

c. value (string)

d. Represent the method to be called to read instance from (typically JDBC wrapper) NOT including the value, e.g., “SQLUtil.getTimestamp(rs, index++)”

4. Value added Read Data (prefix class name with “s_TypeReal.” type converter for Java to database types)

a. name (string)

b. Represents a fully qualified Java class name which needs type conversion, e.g., “s_TypeReal+ClobMetaData.class.getName( )”

c. value (Java class)

d. Represent the associated Java class to handle this reference type (e.g. String.class)

Normalized Java Meta Data

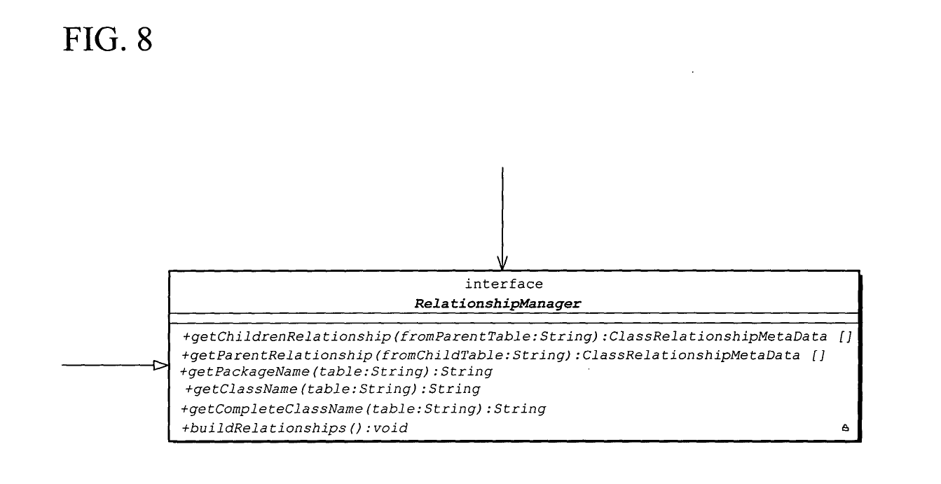

The class ClassMetaData (FIG.6) is the main building block. This class represents attributes for generating Java Source Code. The decoration this class requires for relationship automatic code generation is defined via a real implementation of a RelationshipManager (FIG. 8), which this class references.

Code Generator Sources

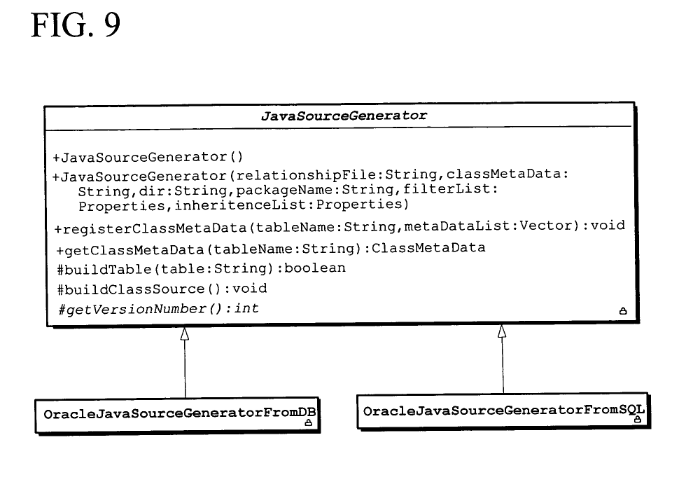

The manager that handles the creation of Java source code from a list of ClassMetaData (FIG. 6) instances will always derive from the abstract base class JavaSourceGenerator (FIG. 9). The way the ClassMetaData (FIG. 6) list is gathered is defined by a concrete subclass. Currently there are two implementations for code generation; both are biased towards Oracle type meta data mappings (i.e. the real implementing class for ClassMetaData (FIG. 6) is an instance of OracleClassMetaData (FIG. 7). One gains its generation information from a source database: OracleJavaSourceGeneratorFromDB (FIG. 9), the other from a SQL script containing DDL: OracleJavaSourceGeneratorFromSQL.

While the exemplary embodiment of this invention is described for an Oracle implementation, one skilled in the art will appreciate that this invention can be implemented for any JDBC compliant database vendor.

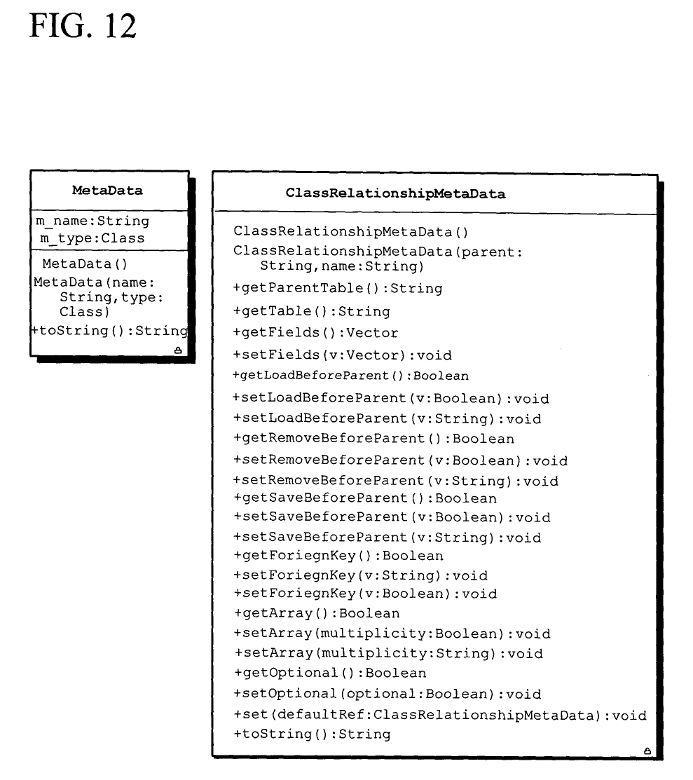

Any JavaSourceGenerator implementation will create instances of the class MetaData (FIG. 12), as any database table has a name and associated fields: the fields being modeled as a list of MetaData instances holding field name and type (the type gained from the ClassMetaData.getClassFromMetaData method).

Java Code Generation

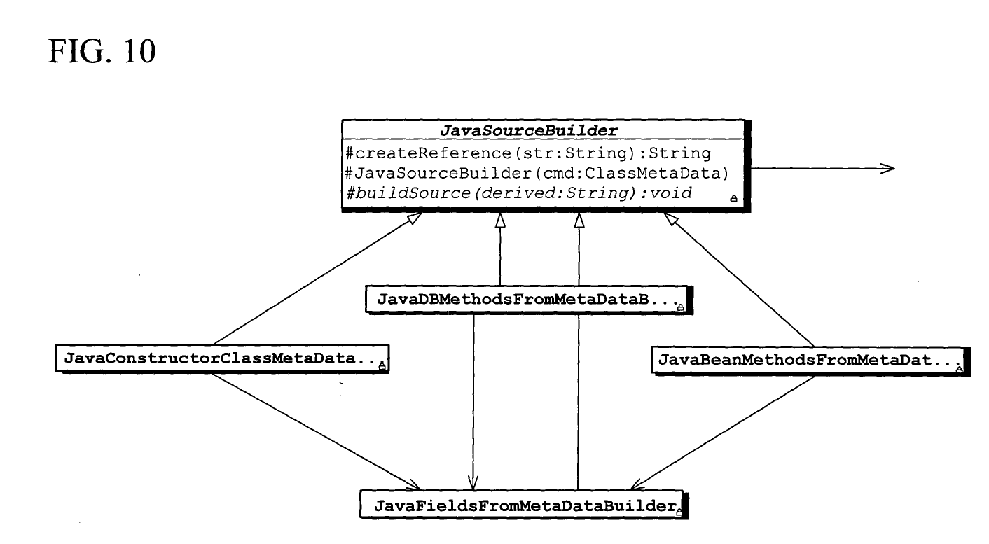

Any type of Java Code generation code will always derive from the abstract base class JavaSourceBuilder FIG. 10.

Generated Automatic Relationship Management

Any parent that has children has those associations automatically generated. This means the following methods will be generated automatically with child relationships:

1. list management auto generated.

2. load/save/remove updated to include relationships.

3. finders added to handle child/parent relationships.

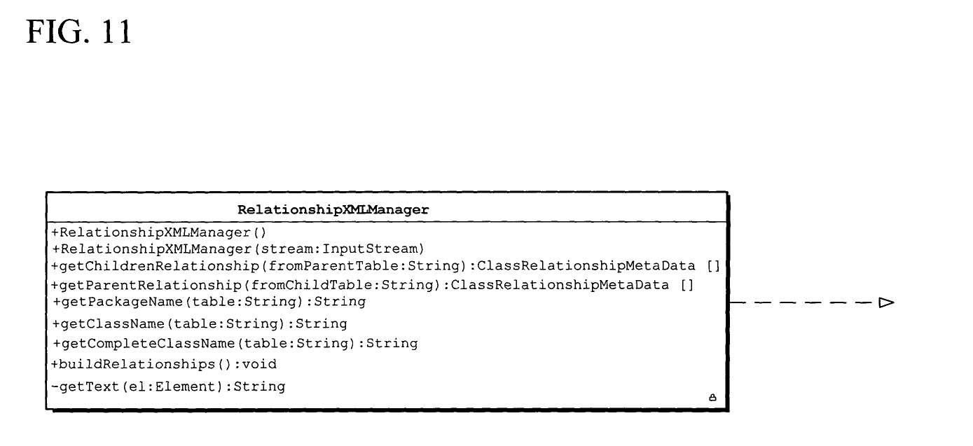

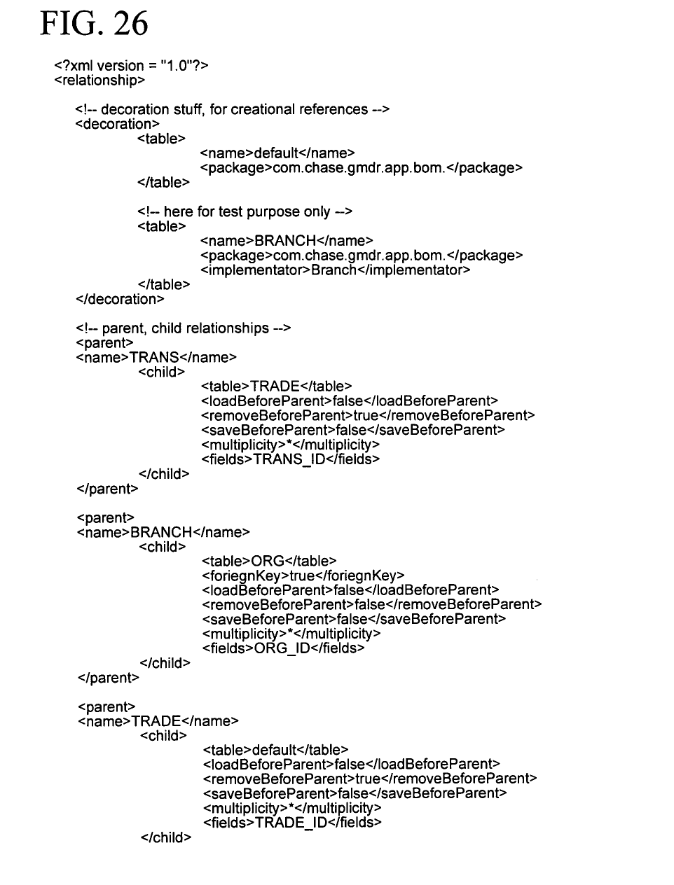

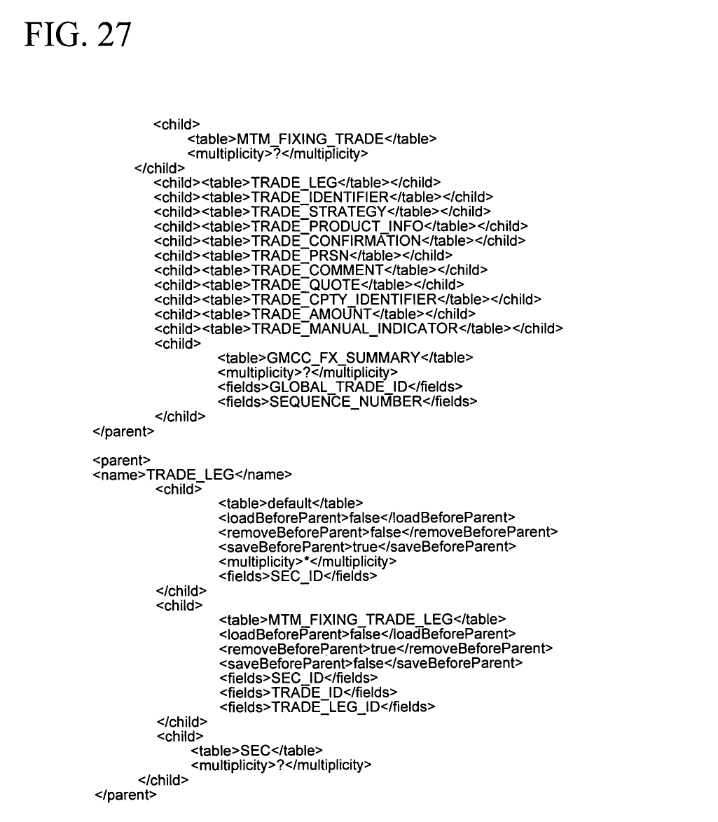

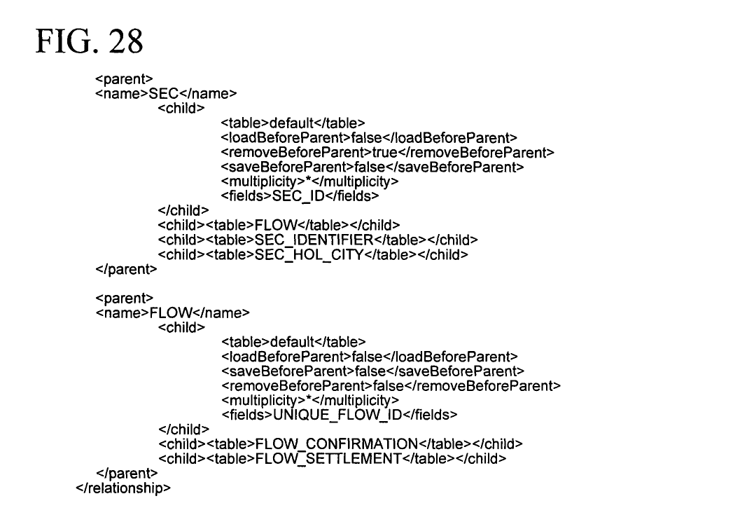

The management interface RelationshipManager (FIG. 8) is currently realized using XML as the relationship mapping tool, via a real implementor class RelationshipXMLManager FIG. 11. Relationships are managed by defining parent/child/foreign key relationships in an XML file (An example may be found below labeled GMDRrelationship.xml, FIGS. 26-28). This holds default relationship values for all children, and specific references.

The data it holds includes all the standard relationship expected, for instance:

1. Parent name and associated list of children

2. For each child, the key fields which map them to the parent(s)

3. For each child, the multiplicity

4. For each child, the pre/post condition associated with saving/loading/removing in relation to the parent (e.g., does this child need to be saved before the parent).

This information is typically available from a database source. However, some relationships cannot be determined or are not required and the source of generation of code may not come from the database. This reason is why this relationship information is maintained as a separate concern from the underling source of table meta-information.

XML Relationship Tag Description

The XML Relationship Tag description is defined as:

1. under the <parent> reference

a. the parent table

b. name of the parent

c. list of children (1 . . . x)

2. under the <children> reference

a. name of child table

b. field (which has relationship with)

c. multiplicity (×, *, ?)

d. Save/Remove/Load indicators to determine if save before or after parent, etc.

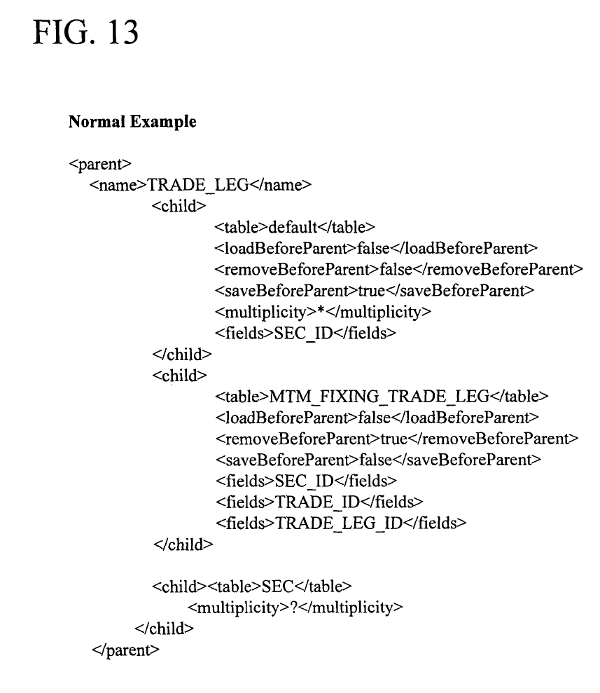

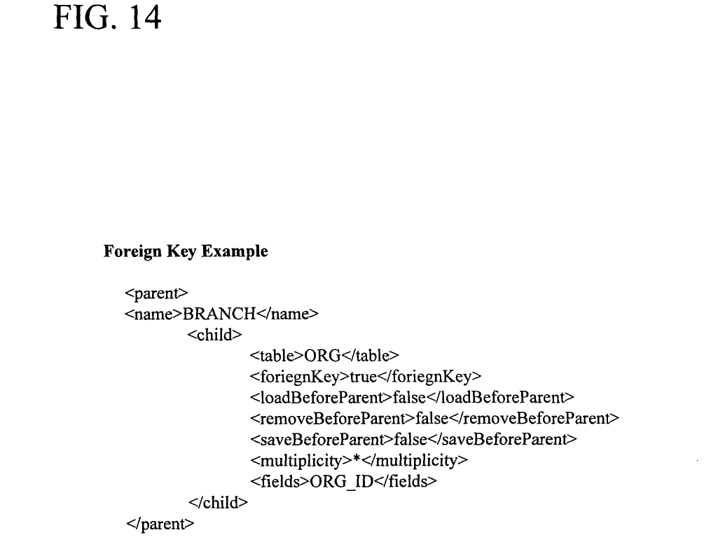

Two example relationship references under this closure are defined in FIGS. 13 and 14.

In XML decoration, as the generated code is typically created in a separate directory package to the real decorator code, any reference in the generated code needs to reference the decorator class, rather than the generated class (it may be decorating a method in the generated class, otherwise the overloaded methods will never be called). To enable this, the <decoration> section is provided which defines, potentially for each table name, the following:

XML Decoration

1. under the <decoration> reference

a. a list of table references (1. . . x)

2. under the <table> reference

a. name of table

b. package where will reside

c. partition (optional reference to a partition name if table in a partition)

d. sqlOptimise (option list of name/value pairs representing SQL optimisation hints)

</name>

<value>

e. assignPKFields (optional list of PK fields which require values assigned against)

</name>

</value>

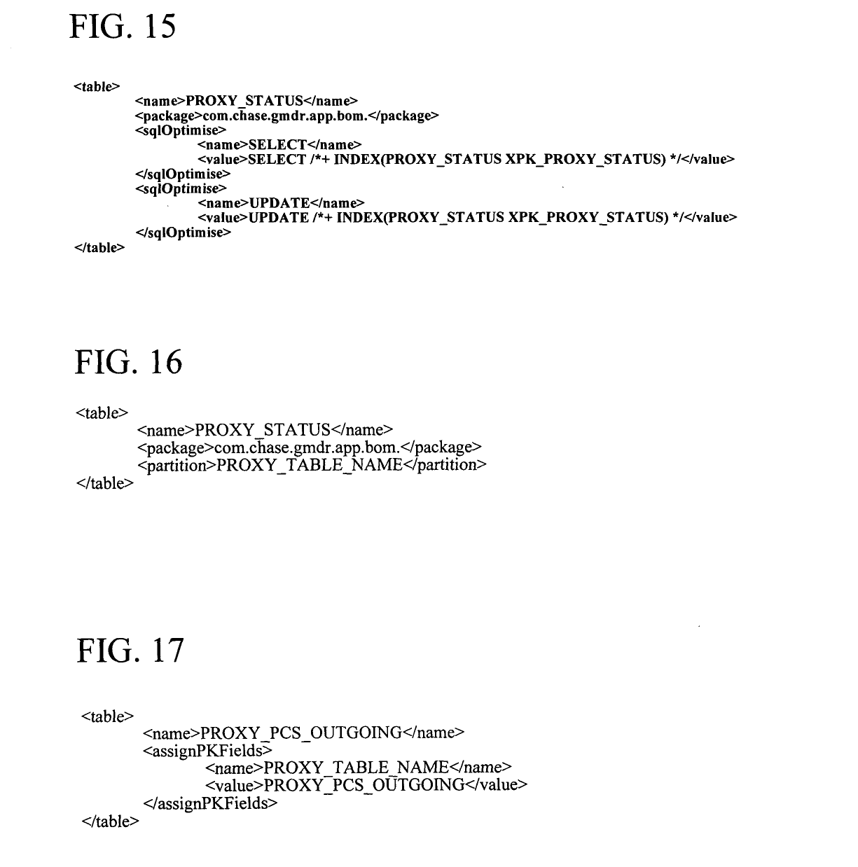

An example of optimization hints under this closure is defined in FIG. 15. An example of partition hints under this closure is defined in FIG. 16. An example of primary key field hints under this closure is defined in FIG. 17. An example decoration reference under this closure is defined in FIG. 18. Note that in all cases “default” is defined if relationship properties are to be used globally under a particular tag context.

Relationship Code Template

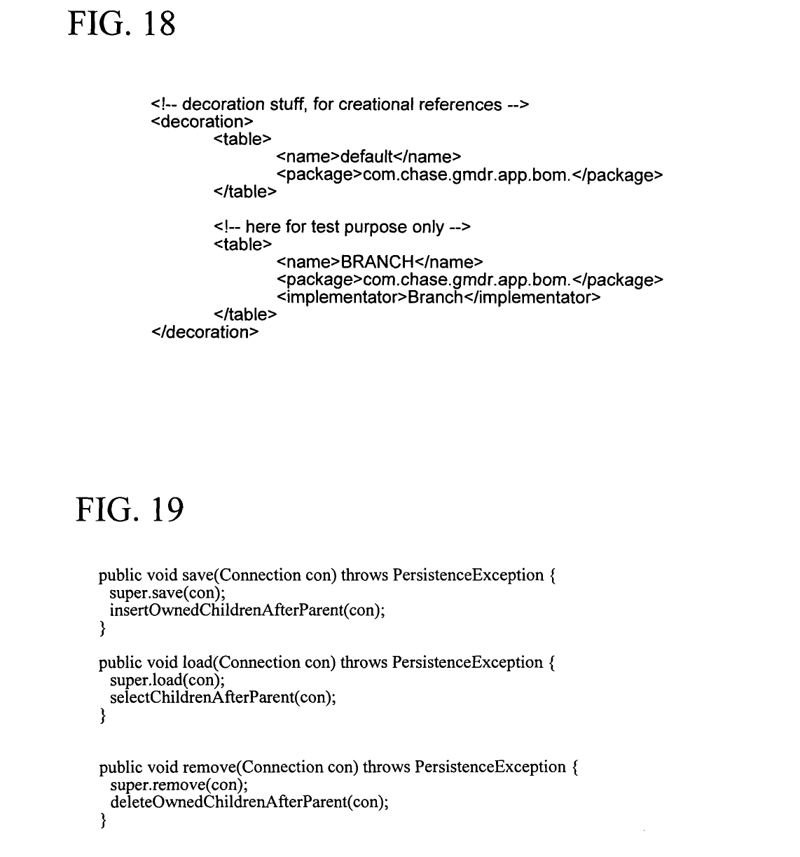

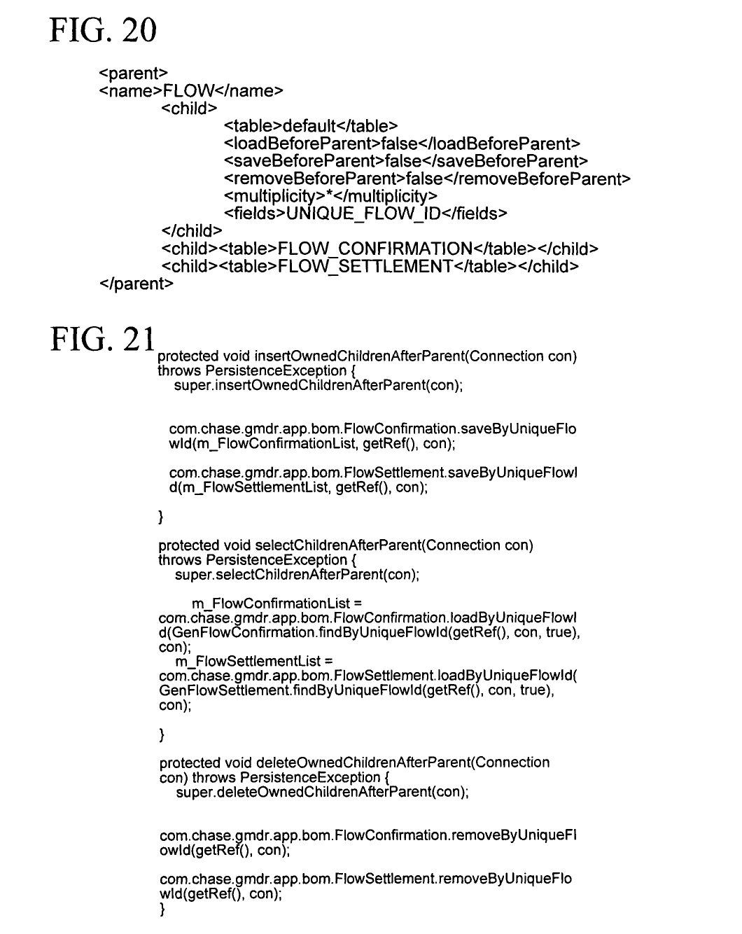

Turning now to FIG. 19, a generated code template for a parent/child relationship is shown. FIG. 20 defines the parent/child relationship that was used to generate this code. The FLOW and associated children are used as a template example of the generated code produced because of the relationships it defines.

Child Relationships

For every child relationship, the following template static method is generated. Typically, a real implementation may override these methods with decoration before calling the base methods.

1. public static void saveBy<x>(java.util.List <x>, BoMobjectRef parent, Connection con) throws PersistenceException

2. public static java.util.List findBy<x>(BoMobjectRef parent, Connection con, boolean isoptional) throws PersistenceException

3. public static void removeBy<x>(BOMObjectRef parent, Connection con) throws PersistenceException

4. public static java.util.List shallowLoadBy<x>(java.util.List pk, Connection con) throws PersistenceException

5. public static java.util.List loadBy<x>(java.util.List pk, Connection con) throws PersistenceException

In points 1 through 5 above, <X> represents the relationship references all concatenated together by “And,” e.g,. xAndyAndz. In this case the relation is via field UNIQUE_FLOW_ID, resulting in <x> being <UniqueFlowId>, i.e., saveByUniqueFlowId, etc. Parent represents the parent object where these relationship references will be gained, e.g., ((Flow) parent).getUniqueFlowId( ) in this case. In this case FLOW is the parent. The isOptional on the findBy method is set to “true” if the relationship is optional (i.e., 0 . . . x multiplicity, for instance). If set to true (i.e., 1 . . . X multiplicity), an exception will be raised if no relationship exists (an empty list).

Parent Relationships

For every parent relationship the standard BOM save/load/remove will be decorated with the pre/post conditions for relationship management. Note that updating removes all child relationship references before the update is complete. This will be in the form of calling the methods deleteOwnedChildrenBeforeParent or deleteOwnChildrenAfterParent depending upon the parent/child relationship reference.

FIG. 20 show the definition of the partent relationship using the <loadBeforeParent>, <saveBeforeParent> and <removeBeforeParent> tags.

The example of FIG. 21 show the generated code from the parent relationship defined in FIG. 20. Note here the parent calls the generated static methods already outlined. As the static methods are referenced in relation to the decorated class, this means the class (in this case com.chase.gmdr.app.bom.FlowConfirmation can decorate the methods and then call the generated GenFlowConfirmation).

Finders and Loaders Template

In the Finders and Loaders Template, each findBy relationship method follows the EJB convention and returns a list of primary keys representing the BOM under that relationship reference. Each loadBy / shallowLoadBy relationship method expects a list of primary keys as an argument and returns a list of the BOM the PK relationship reference represents.

Finder Helpers

For relationships which are not easily generated there are some finder helper interfaces which are defined in the helper class:

com.chase.gmdr.base.database.SQLFinderUtil.

This helper class contains the following two interfaces:

SQLFinderUtil.SQLFinder

SQLFinderUtil.SQLFinderBuilder

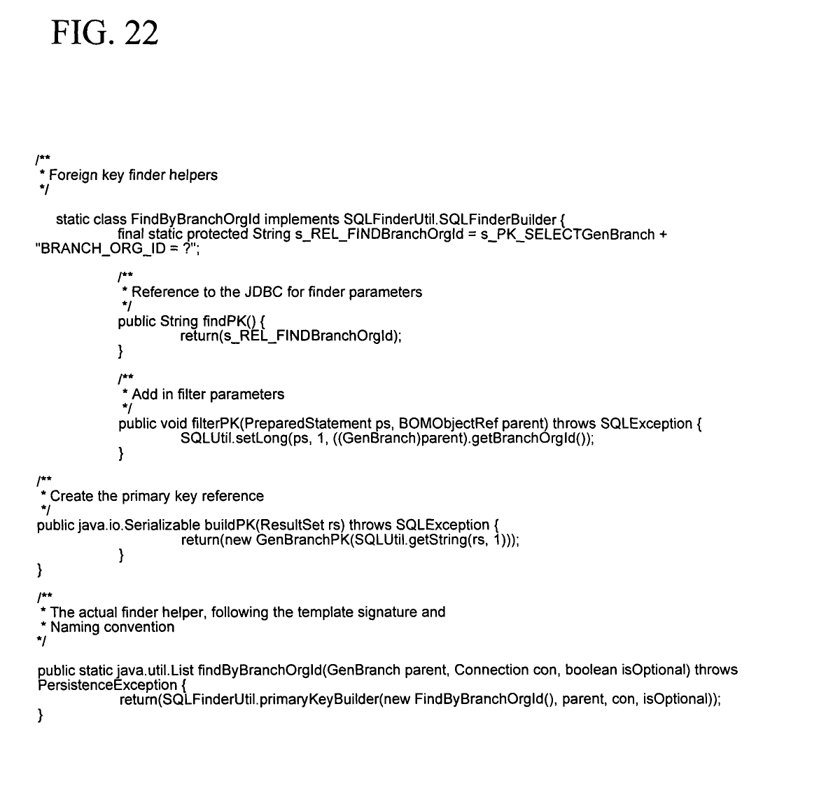

SQLFinderUtil has helpers for finders, loaders, and update classes. All expect a list of primary keys for database references. An example of their use is defined in FIG. 22.

Incremental Loading Template

Loading a bean using the shallowLoad method rather than the load method enables incremental loading of children (if applicable). This means all children (accessed via get . . . ( )) will be loaded automatically. Due to the incremental loading approach the save method will throw an exception is used if the bean is loaded in this way as in this case a partial object representation will be persisted.

Creation of Inheritance

Inheritance of tables is managed by subclass references in the code generation. For each table which needs to be subclassed from another table, the subclasses generated code will extend the super class reference. This does mean that a long chain of subclassing can exist if this is how relationships in SQL are defined.

1. under the <inheritance> reference

a. name of table

b. name of class to subclass. This can be a decorated concrete class.

c. superTable. Name of table that corresponds to the superclass relationship

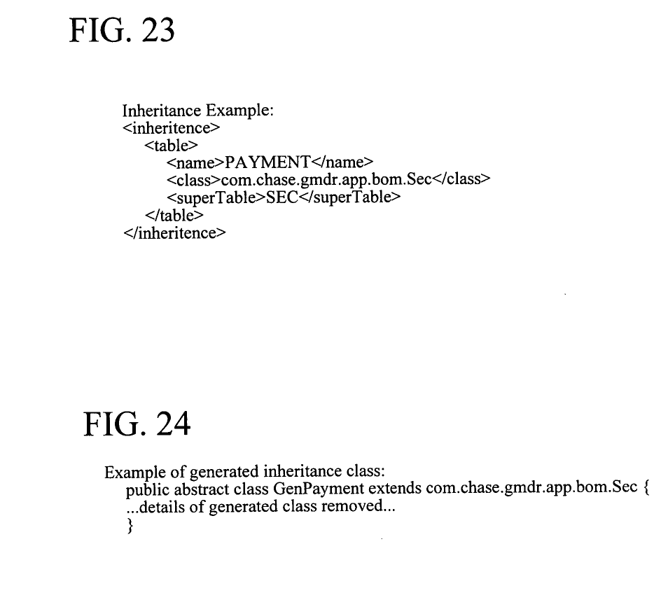

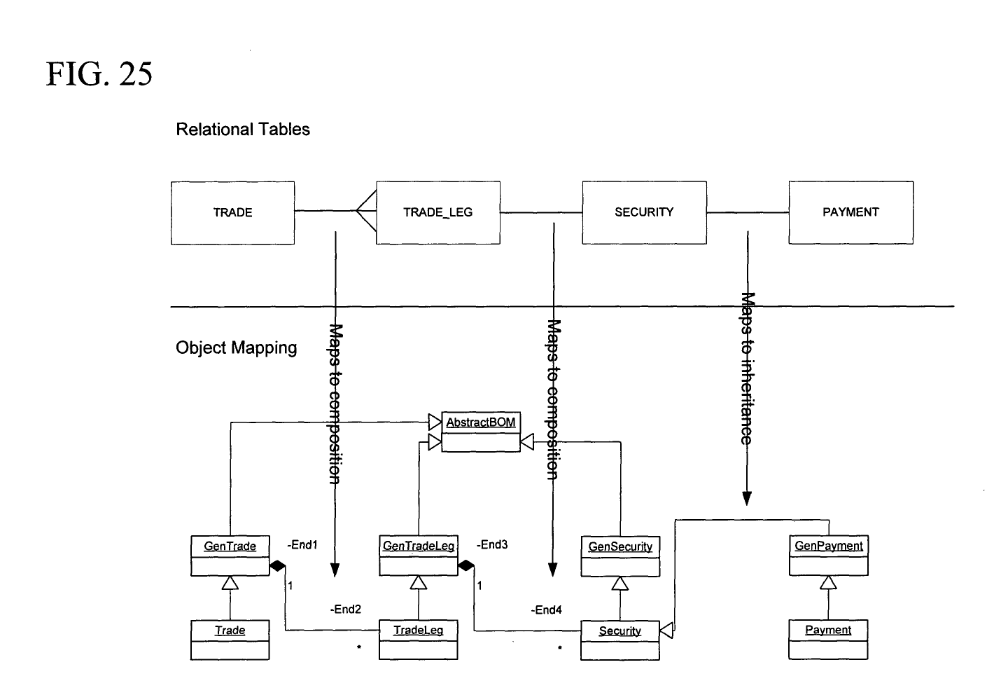

FIG. 23 shows an example relationship reference for inheritance. FIG. 24 shows an example of the code automatically generated from this inheritance relationship. FIG. 25 shows how the relational tables map to the object model.

Creation of Primary Keys and Utility Classes

For each table a serializable primary key reference will be created. This is serializable as this handle means a reference to a BOM can be managed remotely (c.f., EJB beans).

JDBC Code Generated

All references to JBDC currently use the prepared statement interface. This has the advantage that for continuous usage the server will treat the query as a pseudo-stored procedure

FIGS. 26-28 are a GMDR relationship.xml snapshot.

It is to be understood that the above-described embodiment is merely illustrative of the present invention and that many variations of the above-described embodiment can be devised by one skilled in the art without departing from the scope of the invention. It is therefore intended that such variations be included within the scope of the following claims and their equivalents.

What is claimed is:

1. A method for representing a relational database table as a object in an object-oriented operating system comprising:
providing a reference to a primary key having a one-to-one mapping to a table entry in said relational database;
overloading the load method in the object-oriented operating system to load a latest instance of a table entry; and
overloading a save method in the object-oriented operating system to save an instance of a table entry.

2. A method in accordance with claim 1 further comprising:
overloading a remove method in the object-oriented operating system to remove an instance of a table entry.

3. A method in accordance with claim 2 wherein overloading a remove method in the object-oriented operating system removes itself and any child instances.

4. A method in accordance with claim 1 wherein overloading a load method in the object-oriented operating system loads itself and any child instances.

5. A method in accordance with claim 1 wherein overloading a save method in the object-oriented operating system saves itself and any child instances.

6. A method in accordance with claim 1 further comprising:
defining meta data relationship classes to define the relationship between a database type and its equivalent object-oriented data type.

7. A method in accordance with claim 1 further comprising:
providing a read data reference to convert data types from object-oriented data types to relational database data types.

8. A method in accordance with claim 1 further comprising:
providing a write data reference to map data from object-oriented data to relational database data.

9. A method in accordance with claim 1 further comprising:
providing a read type converter reference to convert data types from relational database data types to object-oriented data types.

10. A method in accordance with claim 1 further comprising:
providing a value added write data reference to convert data from relational database data to object-oriented data.

11. A method in accordance with claim 1 further comprising:
automatically generating Java code from a data source.

12. A method in accordance with claim 1 further comprising:
automatically generating Java code from database meta data.

13. A method in accordance with claim 1 further comprising:
automatically generating Java code from DDL.

14. A method in accordance with claim 1 further comprising:
allowing vendor-specific SQL hints to be added to generated code to improve performance.

15. A method in accordance with claim 1 wherein generated code is independent of a specific J2EE technology, database, external service and third-party products.

16. A method in accordance with claim 1 further comprising:
allowing incremental loading.
